(19) United States
(12) Patent Application Publication
(10) Pub. No.: US 2010/0031275 A1
(43) Pub. Date: Feb. 4, 2010

(54) METHOD FOR DISPLAYING A WINDOW

(75) Inventor: Wei-Ling Hsieh, Beijing (CN)

Correspondence Address: SCHWEGMAN, LUNDBERG & WOESSNER, P.A., P.O. BOX 2938, MINNEAPOLIS, MN, 55402, US

(73) Assignee: Eunovation Int'l Limited, Hong Kong (CN)

(21) Appl. No.: 12/326,498

(22) Filed: Dec. 2, 2008

(30) Foreign Application Priority Data
Aug. 4, 2008 (CN) 200810117737.6

(51) Int. Cl. G06F 9/44

(52) U.S. Cl. 719/328

(57) ABSTRACT

The present invention discloses a method for displaying a window. The method comprises hanging an application programming interface (API) hook onto an API for opening a window, wherein the API hook is adapted to designate a display position of the window as the input desktop; and running the API hanged with the API hook to open the window. The present invention can ensure the window to be open on the correct desktop. Especially, it can overcome the problem that, in the circumstance of the OS of Windows Vista Service Pack1, all the windows will be opened on the default desktop when a virtual desktop is adopted.

### CROSS-REFERENCE TO RELATED APPLICATIONS

This application claims the priority benefit of China Patent Application No. 200810117737.6, filed on Aug. 4, 2008, entitled “Method for Displaying a Window”. The contents of the above identified applications are incorporated herein by reference in its entirety.

### FIELD OF THE TECHNOLOGY

The present invention relates to a method for displaying a window in an operating system, particularly to a method for modifying a display desktop of the window. BACKGROUND OF THE INVENTION

Computer techniques and applications develop very fast, which already cover every aspect of people's life. In order to suit different needs of each person, personal computers are all provided with their own system configuration, accustomed programs and documents. In order to use the accustomed programs and process their own documents in their own familiar system configuration at any moment, many users carry their own laptop computers with themselves. For the reason of weight and bulk, even a laptop computer is also a big burden. The best way is to pack the documents, system configuration and programs and put them into an external storage (e.g. USB drive, or an external hard drive, or even a server). All the familiar things can be reproduced as long as taking the external storage and connecting it to any computer at school, Internet Cafe, office, home, or other places. This is based on a virtual environment, which is a special program which runs on the operating system (OS) of a computer. By using the virtual environment, a user can dynamically adjust the OS of the computer to a user-familiar environment with user's documents, system configuration, and accustomed programs.

During implementing the present invention, the inventor found the prior art has at least the following shortcomings:

When the OS adopted by a user is Windows Vista Service Pack1, after creating a virtual desktop by using the existing virtual environment technique, when the user tries to open a window on the virtual desktop, the window will appear on the default desktop instead of the input desktop (that is, currently visible desktop) where it is supposed to appear on. For example, the name of the default desktop is “Default”, and that of the virtual desktop created by using the virtual environment technique is “Box1”. When the user click “my computer” on the virtual desktop “Box1”, the window corresponding to “my computer” will appear on the default desktop “Default” instead of the virtual desktop “Box1,” where it is supposed to appear, which results in that the user can not see the window created by himself on the virtual desktop.

### SUMMARY OF THE INVENTION

The object of the present invention is to solve the problem of default desktop on which a window appears so as to make the window display on the input desktop.

In order to implement the above object, the present invention provides a method for displaying a window. The method comprises:
hanging an application programming interface (API) hook onto an API for opening a window, wherein the API hook is adapted to designate a display position of the window as the input desktop; and
running the API hanged with the API hook to open the window.

The method may further comprises starting an explorer of the input desktop by double clicking an explorer icon on the input desktop or choosing the explorer from the “Start” menu.

In this situation, the step of hanging an API hook onto an API for opening a window comprises hanging the API hook onto a creating thread API of the explorer of the input desktop; the API hook further invokes an API for modifying a desktop attribute; and the desktop attribute is set to be the input desktop.

Alternatively, the method may further comprise starting the explorer of the input desktop in the way of a hot key or a command line.

In this situation, the step of hanging an API hook onto an API for opening a window comprises hanging the API hook onto a process-creating API of an explorer of the default desktop; and the API hook further invokes the same API of the input desktop.

It can be seen from the above technical solutions, the present invention, by hanging a hook onto a relevant API for opening the window of the explorer, has the beneficial effect of ensuring the window of the explorer to be opened on the correct desktop.

The present invention will be described in more detail with reference to the drawings and embodiments.

### BRIEF DESCRIPTION OF THE DRAWINGS

FIG. 1 is a flowchart illustrating the embodiment 1 of the method for displaying a window in accordance with the present invention;

FIG. 2 is a flowchart illustrating the embodiment 2 of the method for displaying a window in accordance with the present invention;

FIG. 3 is a flowchart for illustrating the embodiment 3 of the method for displaying a window in accordance with the present invention.

### DETAILED DESCRIPTION OF THE PREFERRED EMBODIMENTS

In order to understand the present invention better, the technical terms of the present invention will be explained first as follows:

Desktop: a picture of OS called desktop. An OS may have many desktops at the same but only one desktop is displayed at a time. Each desktop has a unique name for identification. The name of the default desktop is “Default”.

Input Desktop: Even though there are many desktops existing at the same time, only one of them is visible at a time. The visible desktop is called input desktop. In the prior art, no matter an explorer window is opened on a virtual desktop or a default desktop, the window will be displayed on the default desktop, which will make user confused and inconvenient. The present invention is mainly aimed to solve this problem. Therefore, if there is no special explanation in embodiments of the present invention, the mentioned input desktop is a virtual desktop. For there may be a plurality of virtual desktops, one virtual desktop “Box1” is taken as an example.

Explorer: a program, namely explorer.exe. This program is in charge of showing and managing programs related to a desktop. If this program is not running, the desktop will have no interaction with users and users can not manipulate the desktop at all.

Application Programming Interface (API): a function for being invoked by application programs. The API mentioned in the present invention comprises: a function of ShellExecuteEx for establishing a process, a function of CreateRemoteThread for establishing a remote thread, a function of CreateThread for establishing a local thread, a function of SetThreadDesktop for modifying desktop attributes (Desktop). The desktop attribute (Desktop) is used to designate which desktop a application belongs to, for example, whether the application belongs to the default desktop “Default” or displayed on the virtual desktop “Box1” .

API Hook: inserting a user-defined program in the running program by the way of holding up so as to change functionality.

Process: a program in running status. One process has at least one thread.

Thread: a running unit of a program. The executing of any program starts with the main thread, and creating more thread when needed. When there is no thread in a process, the program ends.

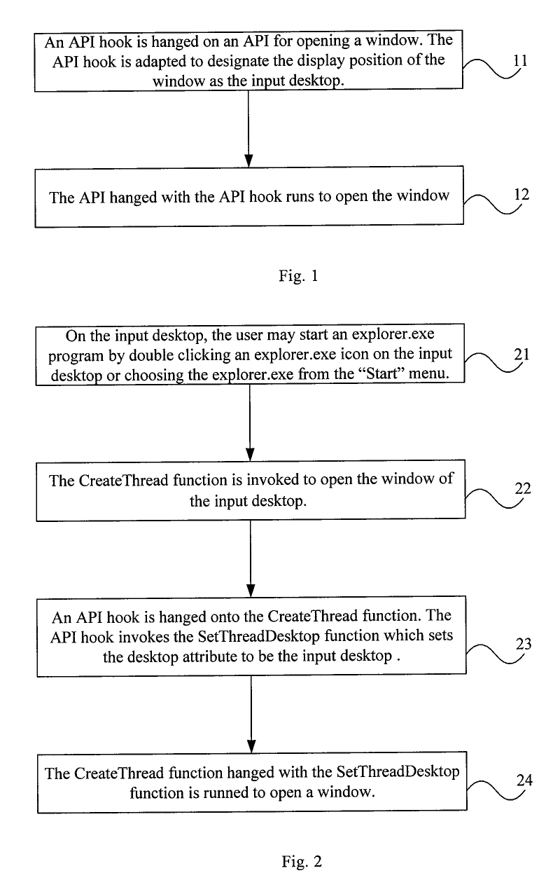

FIG. 1 is a flowchart illustrating the embodiment 1 of the method for displaying a window in accordance with the present invention. The method comprises the following steps:

In step 11, an API hook is hanged on an API for opening an explorer window; the API hook is adapted to designate the display position of the window as the input desktop. The user may start an explorer.exe process by double clicking an explorer.exe icon on the input desktop or choosing the explorer.exe item from the “Start” menu (specifically corresponding to the following embodiment 2). In this situation, the API for opening a window is the CreateThread function; or, the user may start the explorer.exe process by the way of the hot key “win+E” on the input desktop or a command line (specifically corresponding to the following embodiment 3). In this situation, the API for opening a window is the ShellExecuteEx function.

In step 12, the API hanged with the API hook runs to open the window.

In the present embodiment, by setting an API hook and designating the display position of the window as the input desktop in the hook program, the window may be displayed on the input desktop so as to avoid the problem that the window of the explorer are all displayed on the default desktop in the prior art.

FIG. 2 is a flowchart illustrating the embodiment 2 of the method for displaying a window in accordance with the present invention. The method comprises the following steps:

In step 21, on the input desktop “Box1”, the user may start an explorer.exe program by double clicking an explorer.exe icon on the input desktop or choosing the explorer.exe from the “Start” menu. On the virtual desktop “Box1”, double clicking the explorer.exe icon or choosing the explorer.exe program from the “Start” menu will not open a process but only invokes the CreateThread function to open a thread. The problem in the prior art is that, although the thread is located in desktop “Box1”, the window opened by this thread is on the default desktop. Therefore, the present embodiment needs to process the CreateThread function so as to make the window be opened at the correct position.

In step 22, the CreateThread function is invoked to open the window of the input desktop.

In step 23, an API hook is hanged onto the CreateThread function. The API hook invokes the SetThreadDesktop function. Through the SetThreadDesktop function, the desktop attribute (Desktop) of the thread for opening a window is set to be the input desktop “Box 1”. By setting the desktop attribute, it can be ensured that the window is opened at the correct position. For example, if the window is opened on the input desktop, the window will correctly appear on the input desktop.

In step 24, the CreateThread function hanged with the SetThreadDesktop function is run to open a window. For the SetThreadDesktop function has set the desktop attribute to be the input desktop, the window will appear on the input desktop.

The present embodiment provides a flow of starting the explore.exe to open a window by double clicking the explorer.exe icon or starting the explorer.exe program from the “Start” menu. The present embodiment performs hook treatment on the API (CreateThread function) for opening a window. In the hook program—SetThreadDesktop function, the desktop attribute is the input desktop so as to ensure the window to be opened at the correct desktop (input desktop).

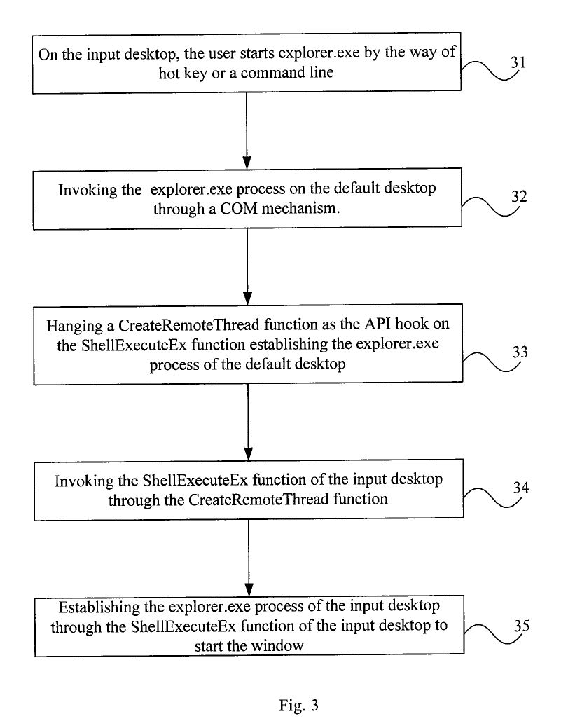

FIG. 3 is a flowchart for illustrating the embodiment 3 of the method for displaying a window in accordance with the present invention. The method comprises the following steps:

In step 31, on the input desktop “Box1”, the user starts explorer.exe by the way of hot key (win+E) or a command line.

In step 32, the OS invokes the ShellExecuteEx function of the shell program of the default desktop through a COM mechanism to establish an explore.exe process. The established process belongs to the default desktop. The step is the problem in the prior art. In the way of hot key or a command line, the explorer.exe process of the default desktop is started, which makes the window to be shown on the default desktop, which is not preferred.

In step 33, by using the API hook technique, the ShellExecuteEx function of the default desktop is held up; instead the CreateRemoteThread function is invoked to create a remote thread (remote thread).

In step 34, through the remote thread, the ShellExecuteEx function of the shell process of the input desktop is invoked to establish the correct process and window.

In step 35, through the function of ShellExecuteEx of the input desktop, explorer.exe process of the input desktop is established to start the window.

The present embodiment provides a flow of starting a program and opening a window by the way of hot key (win+E) or a command line. The embodiment performs hook treatment on the API (the ShellExecuteEx function of the default desktop) for opening a window and sets the hook program, the function of CreateRemoteThread to invoke the ShellExecuteEx function of the input desktop, so as to ensure the window to be shown on the correct desktop ( input desktop).

People skilled in this art can understand that: the implementation of all or part of the steps in the above-mentioned method embodiments can be completed by hardware related to program instructions. The program may be stored in a computer readable storage medium. During running, the program executes the steps comprising the above-mentioned method embodiments. The storage medium comprises the various media which are able to store program codes such as ROM, RAM, diskette or compact disc, etc.

Finally, it should be understood that the above embodiments are only used to explain, but not to limit the technical solution of the present invention. In despite of the detailed description of the present invention with referring to above preferred embodiments, it should be understood that various modifications, changes or equivalent replacements can be made by those skilled in the art without departing from the spirit and scope of the present invention and covered in the claims of the present invention.

What is claimed is:

1. A method for displaying a window, comprising:
hanging an application programming interface (API) hook onto an API for opening a window, wherein the API hook is adapted to designate a display position of the window as an input desktop; and
running the API hanged with the API hook to open the window.

2. The method according to claim 1, further comprising starting an explorer of the input desktop by double clicking an explorer icon on the input desktop or choosing the explorer from a “Start” menu.

3. The method according to claim 2, wherein the step of hanging an API hook onto an API for opening a window comprises hanging the API hook onto a creating thread API of the explorer of the input desktop; the API hook further invokes an API for modifying a desktop attribute; and the desktop attribute is set to be the input desktop.

4. The method according to claim 1, further comprising starting the explorer of the input desktop in the way of a hot key or a command line.

5. The method according to claim 4, wherein the step of hanging an API hook onto an API for opening a window comprises hanging the API hook onto a process-creating API of an explorer of the default desktop; and the API hook further invokes the same API of the input desktop.
